(19) United States
(12) Patent Application Publication
(10) Pub. No.: US 2012/0290474 A1
(43) Pub. Date: Nov. 15, 2012

(54) Payment Network Facilitating Multi-Currency Trade Finance

(75) Inventor: Amy Beth Hoke, Gilford, NH (US)

(73) Assignee: Bottomline Technologies (DE) Inc., Portsmouth, NH (US)

(21) Appl. No.: 13/534,894

(22) Filed: Jun. 27, 2012

Related U.S. Application Data
(63) Continuation-in-part of application No. 13/068,558, filed on May 13, 2011.
Application No. 13/068,558 is a continuation-in-part of application No. 13/136,728, filed on Aug. 9, 2011.
Application No. 13/136,728 is a continuation-in-part of application No. 13/200,581, filed on Sep. 26, 2011.
Application No. 13/200,581 is a continuation-in-part of application No. 13/374,071, filed on Dec. 9, 2011.
Application No. 13/374,071 is a continuation-in-part of application No. 13/374,487, filed on Dec. 30, 2011.

(51) Int. Cl. G06Q 30/04

(52) U.S. Cl. 705/40

(57) ABSTRACT

A system makes payments to vendors, including providing early pay financing of vendor's invoice in a multicurrency environment. Each invoice specifies a transaction currency. At least one of the transaction currency, a payer funding currency, the vendor remittance currency, and the finance currency is of a different currency denomination than the other two. A financier funding amount is the net payment converted to the financier currency at a market exchange rate plus a margin. A vendor resulting remittance is the net payment converted to the vendor remittance currency at a market exchange rate plus a margin. Early payment includes receiving, in a settlement account denominated in the financer currency, the financer funding amount and generating a payment of the resulting remittance amount to a vendor remittance account from a settlement account denominated in the vendor remittance currency.

### TECHNICAL FIELD

The present invention relates to electronic payment and remittance systems and more particularly, to an electronic payment and remittance system which facilitates trade finance in multiple currencies.

### BACKGROUND OF THE INVENTION

Card payments such as a credit card, charge card, or debit card, which are the most common electronic payment mechanism in the consumer world, can be a convenient mechanism for settling business to business transactions in a situation where the vendor and the buyer do not typically operate in the same currency denomination.

For example, when accepting a payment card for a purchase a vendor/merchant pays a transaction or interchange fee and receives almost immediate payment in the currency selected between the vendor/merchant and the acquiring bank. The payer/buyer funds the purchase using the currency selected between the payer/buyer and the issuing bank.

In a typical business to business scenario, a vendor/merchant may ship goods, provide services, or provide other value to the payer/buyer and submit an invoice to the payer/buyer for the goods, services, or other value. The invoice will be denominated in the vendor's transaction currency.

At or about the time the invoice is due, the payer/buyer may elect to pay the invoice using a purchase card. A card number will be provided to the vendor/merchant. The vendor/merchant will initiate payment by obtaining authorization to “charge the card” by the amount due, in the vendor's transaction currency. At this time the acquiring bank will promptly pay the vendor/merchant the amount charged.

The payer/buyer will fund the payment in a currency as agreed between the payer/buyer and the issuing bank. Settlement between the acquiring bank and the issuing bank occurs through the bank card brand provider's settlement and foreign currency transaction systems.

It is speculated that one of the reasons purchasing card payments are not being adopted for business to business transactions as rapidly as adoption for consumer transactions is that the payment is generally made to the vendor on the due date of a receivable which can be 30, 45, 60, or 90 days after shipping goods or providing services, yet the vendor is charged the same transaction or interchange fee as a merchant who receives immediate payment at point of sale when goods or services are provided. There is no built-in mechanism to facilitate early payment of a vendors invoices and, until the issuing bank (on behalf of the payer/buyer) provides authorization to the vendor to charge the card, there is no mechanism for binding the buyer/payer to make payment.

In view of the foregoing, what is needed is an improved an electronic payment and remittance system which provides for facilitating trade financing in a multi-currency environment.

### SUMMARY OF THE INVENTION

A first aspect the present invention comprises a system for making payments from each payer of a community of payers to each vendor of a community of vendors, providing vendor financing, and assessing a finance fee to each vendor electing early payment financing.

The system comprises a database encoded to computer readable medium. The database may comprise a payer registry, a vendor registry, a financer record, and a group of invoice objects.

The payer registry may comprise a group of payer records. Each payer record may be associated with and identify a unique one of the payers within the community of payers and include identification of a payer funding currency. The payer's funding currency may be a currency denomination chosen by the payer for payment of invoices.

The vendor registry may comprise a group of vendor records. Each record may be associated with and identifying a unique one of the vendors within the community of vendors and include identification of a vendor remittance currency. The vendor remittance currency may be a currency denomination chosen by the vendor for receipt of payment of invoices.

The finance record may be associated with and including identification of a financier and including identification of a financer currency. The financer currency may be a currency denomination chosen by the financier to fund early payment of invoices and subsequently receive remittance of invoice amount from the payer.

The group of invoice objects may, for each invoice object, include identification of a transaction payer, identification of a transaction vendor, identification of an invoice amount, identification of a transaction currency, and identification of a payment due date. The transaction payer may be one of the payers of the group of payers and the transaction vendor may be one of the vendors within the payer vendor group associated with the transaction payer.

At least one of the transaction currency, payer funding currency, the vendor remittance currency, and the finance currency may be a different currency denomination than the other two.

The system further includes a payment application comprising instructions stored in a computer readable memory and executed by a processor. The instructions comprise identifying the payment amount of an early payment, denominated in the transaction currency. The payment amount of the early payment may be the invoice amount less a finance fee.

The instructions further include determining a financer funding amount, denominated in the financer currency. The financer funding amount may be the payment amount of the early payment converted to the financier currency at a market exchange rate plus a margin.

The instructions further include determining a vendor resulting remittance amount, denominated in the vendor remittance currency. The vendor resulting remittance amount may be the payment amount of the early payment converted to the vendor remittance currency at a market exchange rate plus a margin.

The payment instructions further include receiving, in a settlement account denominated in the financer currency, the financer funding amount and generating a payment of the resulting remittance amount to a vendor remittance account from a settlement account denominated in the vendor remittance currency.

To effect payment by the payer, the instructions further include determining a payer funding amount, denominated in the payer currency. The payer funding amount may be the invoice amount converted to the payer funding currency at a market exchange rate plus a margin.

The instructions further include determining a financer resulting payment amount, denominated in the financier currency. The financier resulting payment amount being the invoice amount converted to the financer currency at a market exchange rate plus a margin

The instructions further include: i) receiving in a settlement account denominated in the payer funding currency, the payer funding amount; and ii) generating a payment of the financer payment amount to a financier remittance account from the settlement account denominated in the financer currency.

In one embodiment, the system further comprises an early payment instruction received from the financer and coded to the computer readable database. The early payment instruction comprises an invoice identifier and identification of the finance fee denominated in the transaction currency. In this embodiment, the instructions for identifying the payment amount of an early payment comprises looking up the finance fee from the payment instruction received for the financier.

In another embodiment, the instructions for identifying the payment amount of an early payment comprises calculating the finance fee to charge to the transaction vendor as a function of a finance fee rate multiplied by the period of time between the early pay date and the payment due date.

In either embodiment, the instructions of the payment application further comprise: i) determining a first transfer amount, the first transfer amount being an amount, denominated in the financer currency, necessary to yield the resulting remittance amount when converted to the vendor remittance currency; ii) executing a currency exchange transaction to debit the first transfer amount from settlement account denominated in the financier currency and credit the vendor payment amount to the settlement account denominated in the vendor remittance currency; and iii) if the financer funding amount exceeds the first transfer amount, crediting the excess to an operator account.

Similarly, the instructions may further yet comprise: i) determining a second transfer amount, the second transfer amount being an amount, denominated in the payer currency, necessary to yield the financier payment when converted to the financier currency; ii) executing a currency exchange transaction to debit the first transfer amount from settlement account denominated in the financier currency and credit the vendor payment amount to the settlement account denominated in the vendor remittance currency; and iii) if the payer funding amount exceeds the second transfer amount, crediting the excess to the operator account.

To effect further compensation to the operator of the system, the system may further include a rebate application comprising instruction stored in a memory and executed by a processor. The instructions may comprise: i) determining a total finance fee, the total finance fee being the sum of each finance fee applied to each early payment made by a financier during the predetermined period of time; ii) determining an operator portion of the finance fee, the operator portion of the finance fee being the product of the total finance fee multiplied by a fractional value between zero and one; and iii) debiting the financier account and crediting the operator account, the operator portion of the finance fee.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram representing architecture of a system for making payments from each payer of a community of payers to each vendor of a community of vendors, all in accordance with an exemplary embodiment of the present invention;

FIG. 2 is a block diagram representing a payer in accordance with an exemplary embodiment of the present invention;

FIG. 3 is a block diagram representing a vendor in accordance with an exemplary embodiment of the present invention;

FIG. 4 is a table diagram representing a matching of sensitivity scores to industry codes in accordance with an exemplary embodiment of the present invention;

FIG. 5a is a table diagram representing data elements stored in, and relationships between data elements stored in, a vendor registry in accordance with an exemplary embodiment of the present invention;

FIG. 5b is a table diagram representing data elements stored in, and relationships between data elements stored in, a payer registry in accordance with an exemplary embodiment of the present invention;

FIG. 5c is a table diagram representing data elements stored in, and relationships between data elements stored in, a participating bank registry in accordance with an exemplary embodiment of the present invention;

FIG. 5d is a table diagram representing data elements stored in, and relationships between data elements stored in, a remittance database in accordance with an exemplary embodiment of the present invention;

FIG. 5e is a table diagram representing an invoice database in accordance with an exemplary embodiment of the present invention;

FIG. 6a is a flow chart representing a first aspect of operation of a fee tier assignment application in accordance with the present invention;

FIG. 6b is a flow chart representing a second aspect of operation of a fee tier assignment application in accordance with the present invention;

FIG. 7 is a graphic depicting an exemplary user interface for fee tier assignment in accordance with and exemplary embodiment of the present invention.

FIG. 8a is a table diagram representing payer centric spend scores and criteria for determining a payer centric spend score in accordance with an exemplary embodiment of the present invention;

FIG. 8b is a table diagram representing payer centric frequency scores and criteria for determining a payer centric frequency score in accordance with an exemplary embodiment of the present invention;

FIG. 8c is a table diagram representing network spend scores and criteria for determining a network spend score in accordance with an exemplary embodiment of the present invention;

FIG. 8d is a table diagram representing network frequency scores and criteria for determining a network frequency score in accordance with an exemplary embodiment of the present invention;

FIG. 8e is a table diagram representing weight factors to apply to in accordance with an exemplary embodiment of the present invention;

FIG. 8f is a table diagram representing rate tiers to apply to in accordance with an exemplary embodiment of the present invention;

FIG. 9 is a ladder diagram representing a combination of data structures and instructions stored in memory and executed by a processor for making facilitating early payment of a vendor's invoices in accordance with an exemplary embodiment of the present invention;

FIG. 10a is a flow chart representing operation of a payment application in accordance with an exemplary embodiment of the present invention;

FIG. 10b is a flow chart representing operation of a payment application in accordance with an exemplary embodiment of the present invention;

FIG. 11 is a diagram representing foreign currency calculations in accordance with an exemplary embodiment of the present invention;

FIG. 12 is a diagram representing an early payment approval in accordance with an exemplary embodiment of the present invention;

FIG. 13a is a flow chart representing exemplary operation of a rebate application in accordance with an exemplary embodiment of the present invention; and

FIG. 13b is a flow chart representing exemplary operation of a rebate application in accordance with an exemplary embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code/instructions which is encoded within computer readable medium accessible to the processor, or a combination of a hardware circuit(s) and a processor or control block of an integrated circuit executing machine readable code encoded within a computer readable medium. As such, the term circuit, module, server, application, or other equivalent description of an element as used throughout this specification is intended to encompass a hardware circuit (whether discrete elements or an integrated circuit block), a processor or control block executing code encoded in a computer readable medium, or a combination of a hardware circuit(s) and a processor and/or control block executing such code.

It should also be appreciated that table structures represented in this application are exemplary data structures only, of a non transitory nature embodied in computer readable medium, and intended to show the mapping of relationships between various data elements. Other table structures, data objects, structures, or files may store similar data elements in a manner that maintains the relationships useful for the practice of the present invention.

Within this application the applicant has depicted and described groups of certain elements. As used in this application, the term group (and the term community) means at least three of the elements. For example, a group of vendors means at least three vendors. When a group, for example a first group, is referred to as being distinct, or distinct from a second group, it means that the first group contains at least one element that is not present in the second group and the second group includes at least one element that is not present in the first group. The use of the term unique with respect to an element within a group or set of elements means that that the element is different then each other element in the set or group.

Within this application, the applicant has used the term database to describe a data structure which embodies groups of records or data elements stored in a volatile or non volatile storage medium and accessed by an application, which may be instructions coded to a storage medium and executed by a processor. The application may store and access the database.

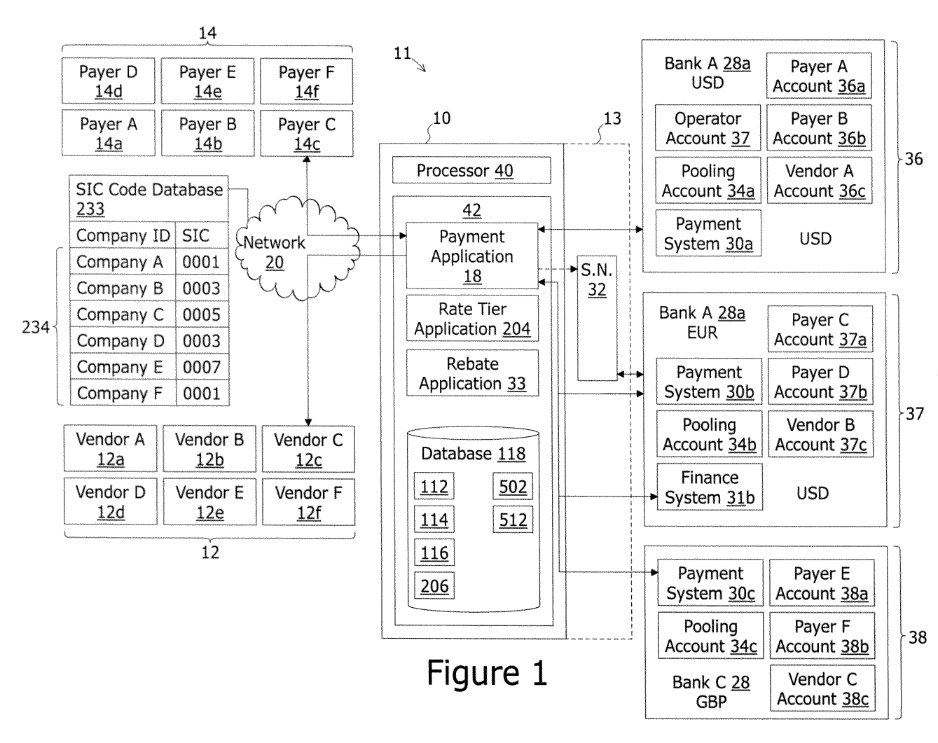

Turning to FIG. 1, an exemplary architecture 11 is shown in which a payment system 10 executes payments from each payer 14a-14f of a community of payers 14 to each vendor 12a-12f of a community of vendors 12 wherein the community of payers 14 comprises multiple distinct subgroups of payers, each subgroup being mutually exclusive of other subgroups. Each subgroup is associated with a distinct bank of a group of participating banks. For example, a first subgroup of payers 14a, 14b, all of which may be customers of participating bank 28a, are associated with bank 28a. A second subgroup of payers 14c, 14d, all of which may be customers of participating bank 28b, are associated with bank 28b. A third subgroup of payers 14e, 14f, all of which may be customers of participating bank 28c, are associated with bank 28c.

The system 10 may further assess a network fee to each vendor in conjunction with executing a payment to the vendor. The network fee assessed to the vendor is based on a variable transaction rate. More specifically, the fee is the product of multiplying the amount of the payment by the rate that is applicable to payments made by the particular payer to the particular vendor. The rate is referred to as “variable” because: i) the rate is variable amongst vendors, the same payer may use different rates for different vendors; and ii) the rate is variable amongst payers, the same vendor may be subjected to different rates, based on the particular payer making the payment.

The network fee may be paid to the operator of the system 10. Further, a portion of the network fees assessed on payments made by each payer may be paid either, or both, as: i) a network fee rebate to the payer; or ii) as variable revenue share, or variable rebate payment to the participating bank with which the payer is associated.

The system 10 may further facilitate financing of, or early payment of, a vendor's invoices in conjunction with subsequent execution of a payment from the payer for such invoice. More specifically, the system 10 may, on an early pay date, determine a finance fee to be charged by a financier (which may be one of the participating banks 28a, 28b, 28c) and make early payment to the vendor for the amount of the invoice less the finance fee. The finance fee may include: i) a financier portion, which is a portion of the finance fee accruing to the financier for financing the invoice; and ii) an operator portion which is a portion of the finance fee accruing to the operation of the system 10. It should be appreciated that, for commercial reasons, a network fee would likely not be charged to a vendor who pays a finance fee in association with early payment of an invoice.

The system 10 is communicatively coupled to each payer 14a-14f of the community of payers 14 and to each vendor 12a-12f of the community of vendors 12 via an open network 20 such as the public internet.

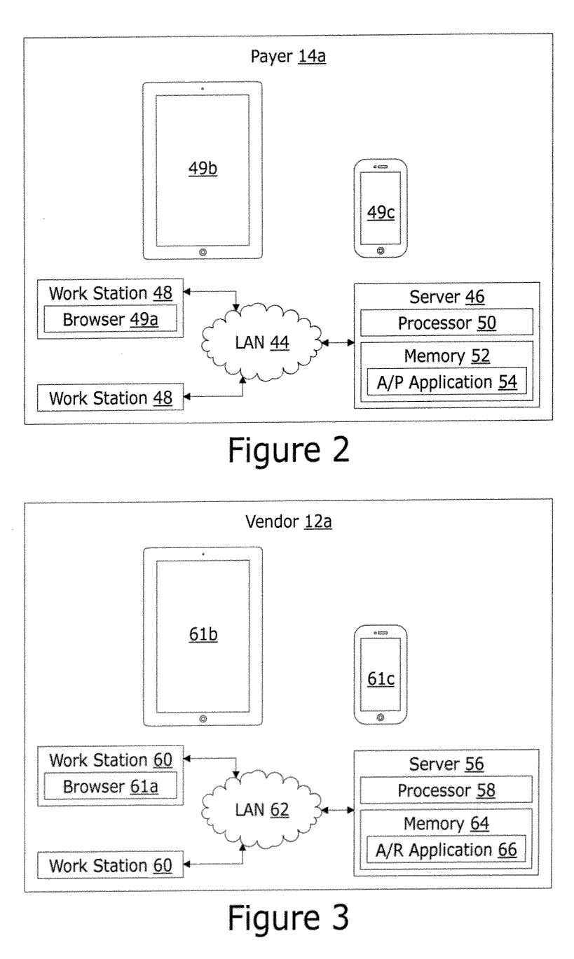

Turning briefly to FIG. 2 in conjunction with FIG. 1, in an exemplary embodiment, each payer, using payer 14a for example, may be a business that includes at least one computer system or server 46. The computer system(s) or server(s) 46 include at least one processor 50 and associated computer readable medium 52 programmed with an accounts payable application 54.

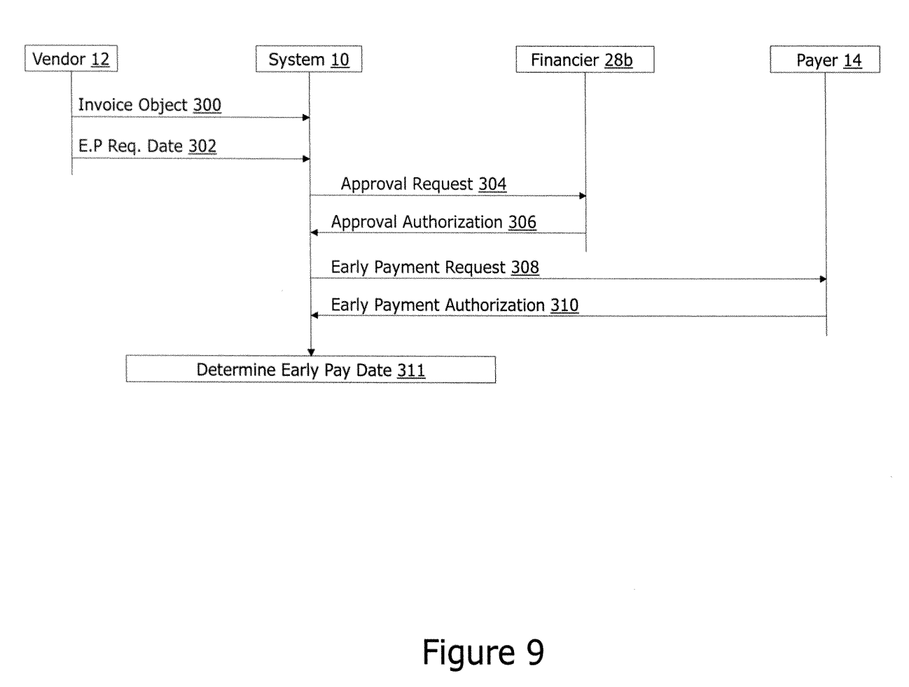

In a typical environment, the computer system(s) or server(s) 46 operating the accounts payable application 54 may be coupled to a local area network 44 and accessed by entitled users of workstations 48 and may be used for managing the payer's accounts payables and issuing payments to its vendors. The accounts payable application 54 may issue the payment instruction 310 as described with respect to FIG. 9.

Each payer, again using payer 14a as an example, may further include one or more access systems for interfacing with the system 10. Exemplary access systems include: i) a web browser 49a on a workstation or other computer which accesses system 10 via a web connection; ii) a tablet computer 49b such as an iPad which accesses the system 10 utilizing a custom client application on the tablet; and iii) other mobile devices 49c such as smart phones which access the system 10 utilizing a custom client application on the mobile device, in each case over permutations of the internet, wired or wireless internet service provider networks, and a local area network.

Turning briefly to FIG. 3 in conjunction with FIG. 1, in an exemplary embodiment, each vendor, using vendor 12a for example, may be a business that includes at least one computer system or server 56. The computer system(s) or server(s) 56 include at least one processor 58 and associated computer readable medium 64 programmed with an accounts receivable application 66.

In a typical environment, the computer system(s) or server(s) 56 operating the accounts receivable application 66 may be coupled to a local area network 62 and accessed by entitled users of workstations 60 and may be used for managing the vendor's accounts receivables and reconciling payments issued by customers (i.e. payers) against amounts due to the vendor. The accounts receivable application 66 may provide the invoice object as described with respect to step 300 (FIG. 9) and provide the early payment request described with respect to step 302 (FIG. 9).

Each vendor, again using vendor 12a as an example, may further include one or more access systems for interfacing with the system 10. Again, exemplary access systems include: i) a web browser 61a on a workstation or other computer which accesses system 10 via a web connection; ii) a tablet computer 61b such as an iPad which accesses the system 10 utilizing a custom client application on the tablet; and iii) other mobile devices 61c such as smart phones which access the system 10 utilizing a custom client application on the mobile device, in each case over permutations of the internet, wired or wireless internet service provider networks, and a local area network.

Returning to FIG. 1, for purposes of illustrating the invention, three of the group of participating banks 28a, 28b, and 28c are depicted. Each bank, for example bank 28a, may include a payment system 30a (i.e. instructions coded to a computer readable medium and executed by a processor) which manages deposit accounts 36, including execution of credit and debit transactions to deposit accounts 36 in a traditional manner. Similarly bank 28b may include a payment system 30b (i.e. instructions coded to a computer readable medium and executed by a processor) which manages deposit accounts 37, including execution of credit and debit transactions to deposit accounts 38 in a traditional manner. Bank 28c may include a payment system 30c (i.e. instructions coded to a computer readable medium and executed by a processor) which manages deposit accounts 38, including execution of credit and debit transactions to deposit accounts 38 in a traditional manner.

For purposes of illustrating the present invention, each of the participating banks 28a, 28b, 28c operates in a currency unique from the currencies of the other participating banks 28a, 28b, 28c such that deposit accounts 36 are denominated in a first currency, deposit accounts 37 are denominated in a second currency, and deposit accounts 38 are denominated in a third currency with each of the first, second, and third currencies being unique.

The payment system 30a, 30b of each bank 28a, 28b may further be coupled to settlement networks 32 which transfers funds between banks for settlement of payments between accounts at different banks. Exemplary settlement networks include the National Automated Clearing House Association (NACHA) for settling USD ACH transactions, the Federal Reserve for settling USD wire transactions, foreign central bank networks for settling foreign currency payments, and proprietary foreign exchange networks. The settlement networks 28 may also include a card payment system operator such as American Express or a bank card brand provider—or an association, such as bank card brand providers Visa or MasterCard, which settles payments typically referred to as card payments.

Each bank may include, and each banks payment system 30a, 30b, 30c may also manage, customer deposit accounts 36 (for bank 28a), 37 (for bank 28b), and 38 (for bank 28c). Each customer account is an account to which credit and debit transactions are posted representing credits and debits to the funds of a particular customer associated with the account (i.e. the account holder). For example, bank 28a may have a customer account 36a for Payer 14a, a customer account 36b for payer 14b, and a customer account 36c for vendor 12a. For example, bank 28b may have a customer account 37a for payer 14c, a customer account 37b for payer 14d, and a customer account 37c for vendor 12b. For example, bank 28c may have a customer account 38a for payer 14e, a customer account 38b for payer 14f, and a customer account 38c for vendor 12c.

Each customer account for a payer may be a deposit account such as a commercial checking account denominated in the currency managed by the bank. Each customer account for a vendor may be a deposit account such as a commercial checking account or a merchant services account such as an account funded upon settlement of a card payment transaction in the currency denomination of the bank.

Each participating bank 28a, 28b, 28c may further include, and the bank's payment system 30a, 30b, 30c may further manage, a settlement or pooling account 34a, 34b, 34c which may be a fiduciary consolidation account with legal title to funds therein belonging to the bank, such as a commercial checking account, to which credits and debit transactions are posted representing credits to fund payments to be issued by payers and debits to disburse payment to vendors. Again, the pooling account may be denominated in the currency managed by the bank.

Each participating bank, using bank 28b as an example, may further include a financing system 31b which, as will be discussed herein, receives early payment financing requests from the system 10. Each request may include identification of the vendor requesting early payment financing, identification of the payer to which an invoice is issued, and the amount requested to be financed—or it may include the entire invoice object. The financing system 31b may, on an automated basis, approve or reject the request based on: i) whether the vendor is eligible for financing; and ii) whether the invoice is eligible for financing (i.e. at a minimum the invoice is to a payer which is participating in early payment financing.

For purposes of illustrating this invention, bank 28a may further include, and the banks' payment system 30a may further manage, an operator account 37 which may be a deposit account, such as a commercial checking account, to which credits and debit transactions are posted representing credits and debits to funds of the operator of the system 10.

In an exemplary embodiment, the payment system 10 may be communicatively coupled to each payment system 30a, 30b, 30c and to the financing system 31b. In another exemplary embodiment, the payment system 10 may further be coupled to the one or more of the settlement networks 32, or may alternatively be coupled to one or more settlement networks 32 in lieu of being coupled to payment systems 30a, 30b, 30c of participating banks 28a, 28b, 28c.

In yet another exemplary embodiment, one or more settlement networks 32 may be part of the payment system 10 as depicted by the dashed line 13 in FIG. 1. For example, if the payment system 10 is operated by a bank card association the payment system 10 may include a proprietary settlement network 32.

The payment system 10 may be a computer system of one or more servers comprising at least a processor 40 and computer readable medium 42. The computer readable medium may include encoded thereon a payment application 18, a rate tier assignment application 204, a rebate application 33 and database 118. Each of the payment application 18, the rate tier assignment application 204, and the rebate application 33 may be a computer program comprising instructions embodied on computer readable medium 42 and executed by the processor 40. The database 118 may include data structures, also referred to as tables, as described herein.

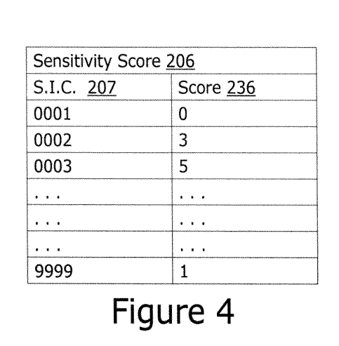

Referring to FIG. 4 in conjunction with FIG. 1, the database 118 may include, as one of its data structures, sensitivity score table 206. The sensitivity score table 206 may associate each industry code of a group of industry codes 207 to a sensitivity score 236. The group of industry codes 207 may be the four digit Standard Industrial Classification (SIC) code promulgated by the US Government; the six digit North American Industry Classification System (NAICS) code promulgated by the US Government, or the codes of any other industry classification system which utilizes alpha numeric characters or other code values to classify industries and commercial activities.

The sensitivity score 236 assigned to each industry code may be one of a group of discrete score values such as score values 1, 2, 3, 4, and 5 which represents how sensitive typical participants in such industry are to a fee charge related to receipt of payments. This measure or sensitivity may be determined based on evaluations of historical information related to industry participants accepting fees or other empirical evaluations or methods of study.

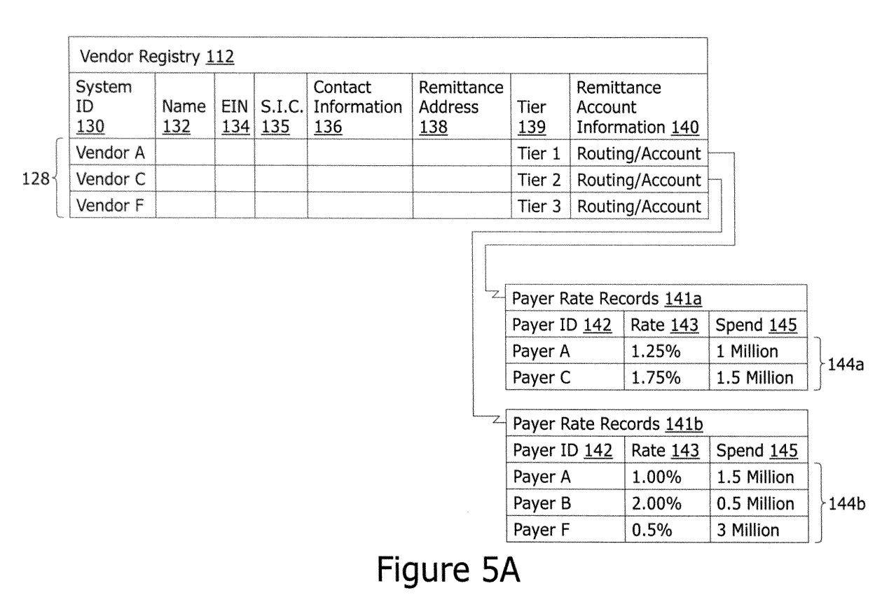

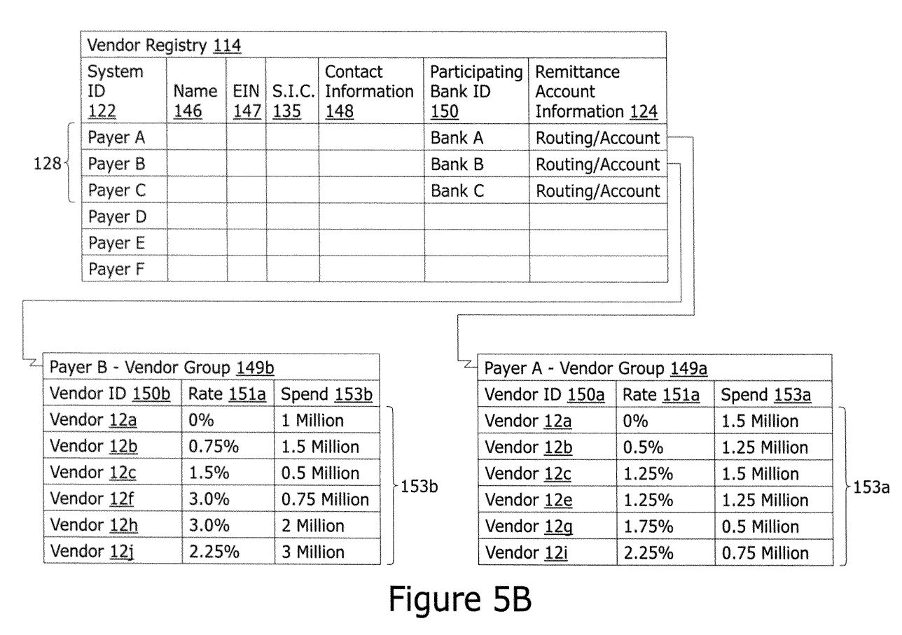

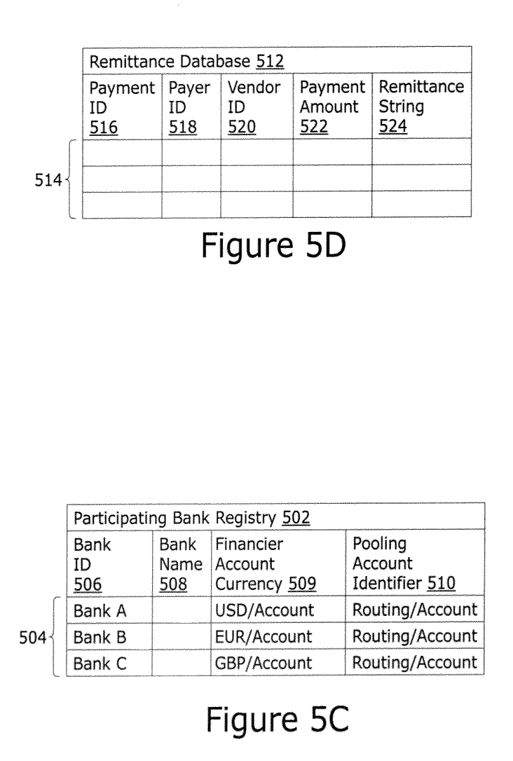

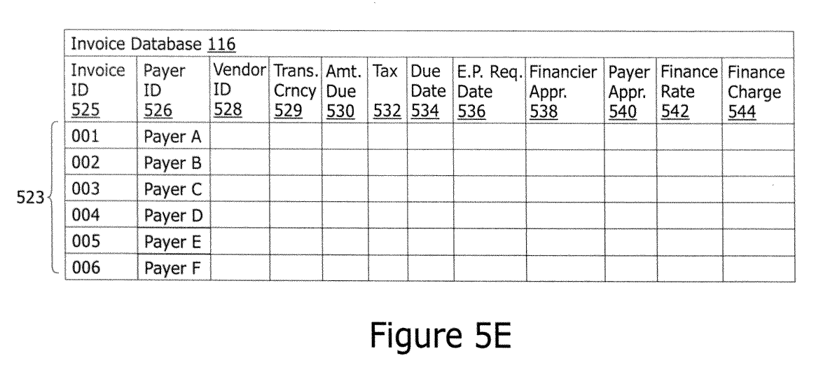

Turning briefly to FIG. 5a in conjunction with FIG. 1, the database 118 may further include, as one of the data structures, a vendor registry 112. The vendor registry 112 may comprise a group of vendor records 128. The group of vendor records 128 may comprise unique records, each of which is associated with, and identifies, a unique one of the vendors of the community of vendors 12 by inclusion of a unique system ID (for example, Vendor A, Vendor B, and Vendor C) within a system ID field 130 of the record.

Also associated with the vendor may be: i) the vendors name included in a name field 132; ii) the vendor's tax identification number included in a tax ID field 134; iii) the vendor's industry code 135; iv) the vendor's contact information included in a contact information field 136; v) the vendors remittance address included in a remittance address field 138; and vi) the vendors remittance account identifier which identifies the vendor's preferred remittance currency and the account, denominated in that currency, in a remittance account identifier field 140.

The vendor's name 132 may be the official name of the entity as recorded in official records of the jurisdiction in which it is formed and as used for titling its bank accounts, including its remittance account.

The vendor's industry code 135 may be the code of the group of industry codes 207 which represents the industry or commercial activity in which the vendor participates.

The vendor's contact information 136 may include the name of an individual in the vendor's accounts receivable department responsible for managing the vendor's accounts receivable matters with the payers 22.

The vendor's remittance address 138 may be an address the vendor typically uses for receiving checks from its customers by regular mail (for example a lock box address).

The vendor's remittance account identifier 140 may identify the bank at which the vendor's remittance account is held, such as by an ABA routing number or other bank identifier applicable to the currency denomination of the account, an account number, and/or other information needed by the payment system 30 and/or settlement network 32 to execute deposits to the vendor's account in accordance with payment authorization instructions provided by a payer.

Each record 128 of the vendor registry 112 may further associate with a unique group of payer rate records 141a, 141b. The unique group of rate records 141 associated with a record 128 of the vendor registry identifies, for that vendor identified in the record 128, those payers which make payment to the vendor and the payer specific transaction rate to apply to payments from the payer to the vendor. For example the record 128 associated with Vendor A may associate with payer rate records 141a. The payer rate records 141a include: i) a record with Payer A populated to the Payer ID field 142, 1.25% populated to the rate field 143 indicating that a network fee rate of 1.25% applies to payments made by Payer A to Vendor A, and $1 Million populated to a spend field 145 indicating that aggregate payments from Payer A to Vendor A over a predetermined period of time (such as one year) is, or is approximately, or is estimated to be, $1 Million dollars; and ii) a record with Payer C populated to the Payer ID field 142, 1.75% populated to the rate field 143 indicating that a network fee rate of 1.75% applies to payments made by Payer C to Vendor A, and $1.5 Million populated to a spend field 145 indicating that aggregate payments from Payer C to Vendor A over a predetermined period of time (such as one year) is, or is approximately, or is estimated to be, $1.5 Million dollars.

Similarly, the record 128 associated with Vendor C may associate with payer rate records 141b. The payer rate records 141b include: i) a record with Payer A populated to the Payer ID field 142, 1.00% populated to the rate field 143 indicating that a network fee rate of 1.00% applies to payments made by Payer A to Vendor C, and $1.5 Million populated to a spend field 145 indicating that aggregate payments from Payer A to Vendor C over a predetermined period of time (such as one year) is, or is approximately, or is estimated to be, $1.5 Million dollars; ii) a record with Payer B populated to the Payer ID field 142, 2.00% populated to the rate field 143 indicating that a network fee rate of 2.00% applies to payments made by Payer B to Vendor C, and $0.5 Million populated to a spend field 145 indicating that aggregate payments from Payer B to Vendor C over a predetermined period of time (such as one year) is, or is approximately, or is estimated to be, $0.5 Million dollars; and iii) a record with Payer F populated to the Payer ID field 142, 0.50% populated to the rate field 143 indicating that a network fee rate of 0.50% applies to payments made by Payer F to Vendor C, and $3 Million populated to a spend field 145 indicating that aggregate payments from Payer F to Vendor C over a predetermined period of time (such as one year) is, or is approximately, or is estimated to be, $3 Million dollars. It should be appreciated that the rate on payments from Payer A to Vendor A is different than the rate on payments from Payer A to Vendor C.

Turning to FIG. 5b in conjunction with FIG. 1, the database 118 may include a payer registry 114. The payer registry 114, may comprise a group of payer records 120. Each record 120 is associated with, and identifies a unique one of the payers 14a-14f of the community of payers 14 by inclusion of a unique system ID (for example Payer A, Payer B, Payer C) within a system ID field 122 of the record.

Also associated with the Payer may be: i) the payer's name included in a name field 146; ii) the payer's tax identification number included in a tax ID field 147; iii) the payer's contact information included in a contact information field 148; v) identification of the participating bank with which the payer is associated in a participating bank field 150; and vi) the preferred funding currency and the payer's transaction or funding account identifier, for a funding account denominated in that currency, included in a funding account information field 124.

The payer's name 146 may be the official name of the entity as recorded in official records of the jurisdiction in which it is formed and as used for titling its bank accounts, including its funding account.

The payer's contact information 148 may include the name of an individual in the payer's accounts payable department responsible for managing the payer's accounts payable matters with the vendors 12.

The participating bank identifier may be a character string identifying the bank—such as the bank's name or ABA routing number or other bank identifier applicable to the currency denomination of the account.

The payer's funding account identifier 140 may identify the bank at which the payer's funding account is held (which is not necessarily the participating bank with which the payer is associated) such as by a routing number, an account number, and/or other information needed by the payment system 20 and/or settlement network 32 to execute transactions to fund the participating bank's pooling account 34a, 34b from the payer's funding account in accordance with payment authorization instructions provided by a payer.

Each record of the payer registry 114 may be associated with a unique payer vendor group table 149, for example the record for payer 14a (with payer ID “Payer A”) may be associated with payer vendor group table 149a and the record for payer 14b (with payer ID “Payer B”) may be associated with payer vendor group table 149b.

Payer vendor group table 149a, associated with payer 14a, may include identification of payer 14a, and a vendor ID for each vendor in Payer 14a's unique payer vendor subgroup. More specifically, the payer vendor group table 140a may include a group of records 153a with each record being unique to one of the vendor's within payer 14a's payer vendor subgroup.

Each record 153a may include a vendor ID within a vendor ID field 150a which identifies the vendor and associates the record with the vendor. For example, payer 14a's payer vendor subgroup may consists of six (6) vendors, vendor 12a, vendor 12b, vendor 12c, vendor 12e, vendor 12g, and vendor 12i, which is fewer then all vendors within the community of vendors 12.

The payer vendor group table 149a also associates each vendor with a transaction rate that applies to payments from Payer 14a to the vendor. More specifically, a transaction rate may be specified as a percentage or fractional value within a transaction rate field 151a of the record 153a associated with the vendor.

For example, identification of zero percent (0.00%) is associated with identification of Vendor 12a indicating that a transaction rate of zero percent (0.00%) applies to payments from Payer 14a to Vendor 12a. A transaction rate of one half percent (0.50%) is associated with identification of Vendor 12b, a transaction rate of one and one quarter percent (1.25%) is associated with identification of Vendor 12c, and Vendor 12e, a transaction rate of one and three quarters percent (1.75%) is associated with identification of Vendor 12g, and a transaction rate of two and one quarter percent (2.25%) is associated with identification of vendor 12i.

The payer vendor group table 149a also associates each vendor with a spend value within a spend field 153a. The spend value represents the aggregate amounts of payments made by the payer, or expected or estimated to be made by the payer, to the vendor during a predetermined period of time such as one year.

For example, identification of $1 million is associated with identification of Vendor 12a indicating that Payer 14a pays, or is estimated or expected to pay, Vendor 12a a total of $1 million over the predetermined period of time. A spend value of $1.25 million is associated with identification of Vendor 12b indicating Payer A pays, or is estimated or expected to pay, Vendor 12b a total of $1.25 million over the predetermined period of time. A spend value of $1.5 million is associated with identification of Vendor 12c. A spend value of $1.25 million is associated with identification of Vendor 12e. A spend value of $0.5 million is associated with identification of Vendor 12g. A spend value of $0.75 million is associated with identification of Vendor 121.

Payer 14b's payer vendor subgroup may consists of six (6) vendors, vendor 12a, vendor 12b, vendor 12c, vendor 12f, vendor 12h, and vendor 12j, which is fewer then all vendors within the community of vendors 12. Within the vendor group table 149b, each of such vendors is associated with a unique record that includes the Vendor ID within the vendor ID field 150b.

The payer vendor group table 149b also associates each vendor with a transaction rate that applies to payments from Payer 14b to the vendor. More specifically, a transaction rate may be specified as a percentage or fractional value within a transaction rate field 151b of the record 153b associated with the vendor.

For example, identification of a transaction rate of zero (0.00%) is associated with identification of Vendor 12a, a transaction rate of three quarters of a percent (0.75%) is associated with identification of Vendor 12b, a transaction rate of one and one half percent (1.50%) is associated with identification of Vendor 12c, a transaction rate of three percent (3.00%) is associated with identification of Vendor 12f and Vendor 12h, and a transaction rate of two and one quarter percent (2.25%) is associated with identification of vendor 12j.

The payer vendor group table 149B also associates each vendor with a spend value within a spend field 153B. The spend value represents the aggregate amounts of payments made by the payer, or expected or estimated to be made by the payer, to the vendor during a predetermined period of time such as one year.

For example, identification of $1 million is associated with identification of Vendor 12a indicating that Payer B pays, or is estimated or expected to pay, Vendor 12a a total of $1 million over the predetermined period of time. A spend value of $1.5 million is associated with identification of Vendor 12b indicating Payer B pays, or is estimated or expected to pay, Vendor 12b a total of $1.5 million over the predetermined period of time. A spend value of $0.5 million is associated with identification of Vendor 12c. A spend value of $0.75 million is associated with identification of Vendor 12f. A spend value of $2 million is associated with identification of Vendor 12h. A spend value of $3 million is associated with identification of Vendor 12j.

Turning to FIG. 5c in conjunction with FIG. 1, the database 118 may include a participating bank registry 502. The participating bank registry 502 may comprise a group of bank records 504. Each record 504 is uniquely associated with, and uniquely identifies, one of the participating banks of the group of participating banks by identification of a unique bank ID (for example Bank A, Bank B, Bank C) in a bank ID field 506 of the record. Each record also includes a bank name field 503 and a pooling account identifier field 510.

The bank's name may be the official name of the bank as recorded in official records of the jurisdiction in which it is formed.

The pooling account identifier 510 may identify the currency of the pooling account as well as the routing number, an account number, and/or other information needed by the payment system 20 and/or settlement network 32 to execute transactions to fund the pooling account, in the denominated currency of the pooling account, in accordance with payment authorization instructions provided by a payer.

Turning to FIG. 5d in conjunction with FIG. 1, the database 118 may include a remittance database 512. The remittance database 512 may comprise a group of bank records 514. Each record 514 is uniquely associated with, and uniquely identifies, a single payment from a payer to a payee. The record 414 includes the unique system ID identifying the payment in a payment ID field 516, identification of the payer making the payment by inclusion of the payer's unique system ID in a payer ID field 518, identification of the vendor receiving the payment by inclusion of the unique system ID of the vendor in a vendor ID field 520, the amount of the payment in a payment amount field 522, and remittance information in a remittance string field 524.

The remittance information may identify the vendor's invoice being paid, goods or services for which payment is being made, or other aspects of an underlying transaction between the payer and vendor giving rise to the payment associated with the record.

Turning to FIG. 5e, the database 118 may further include an invoice database 116. The invoice database may include a group of invoice objects 523. Each invoice object 523 is uniquely associated with, and uniquely identifies, a single invoice issued by a vendor 14 to a payer 12. Each invoice object 523 may include: i) an invoice ID field 525 which may be a unique invoice ID assigned to the invoice object by the system 10; ii) a payer ID field 526 which may include the system ID of the payer to which the invoice is issued; iii) a vendor ID field 528 which may include the system ID of the vendor which issues the invoice; iv) an amount due field 530 which may include the invoice total (total of individual line items); v) a tax field 532 which may include an amount of taxes applied to the invoice; vi) a due date field 534 which may include the date which payment of the invoice by the payer is expected; vii) an early payment request date field 536 which may contain a date, earlier than the payment due date, on which the vendor requests early payment of the invoice; viii) a financier approval date field 538 which may be specify the earliest date on which the financier approves payment; ix) a payer approval date field 540 which may be the date on which the payer commits payment of the invoice on the due date (so that the financier is assured of repayment); and x) a finance rate field 542 representing an interest rate or money factor used to calculate a time dependent portion of the finance fee applicable to an early paid invoice; and xi) a finance charge field 544 which is used to calculate a fixed charge portion of the finance fee applicable to an early paid invoice.

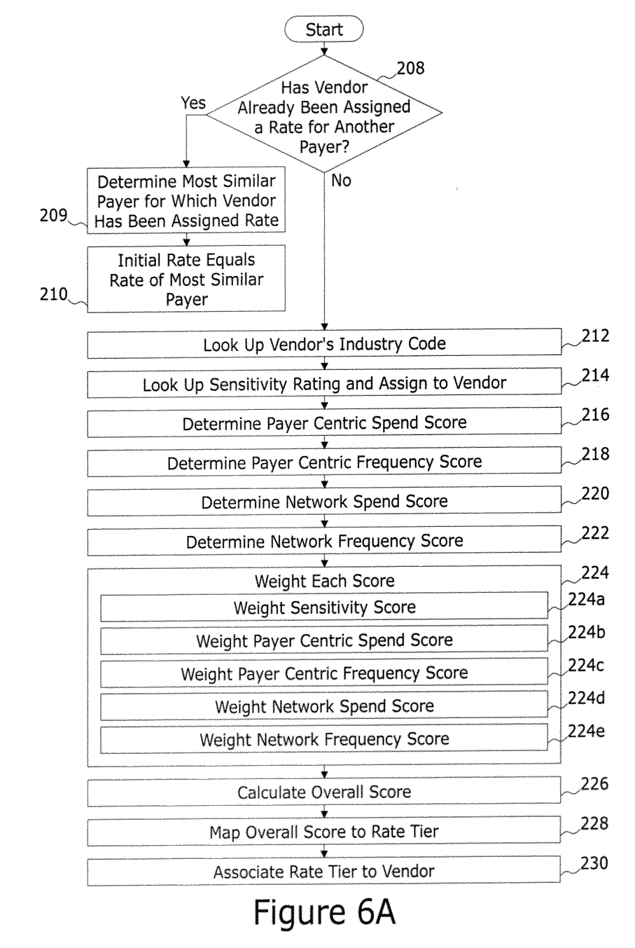

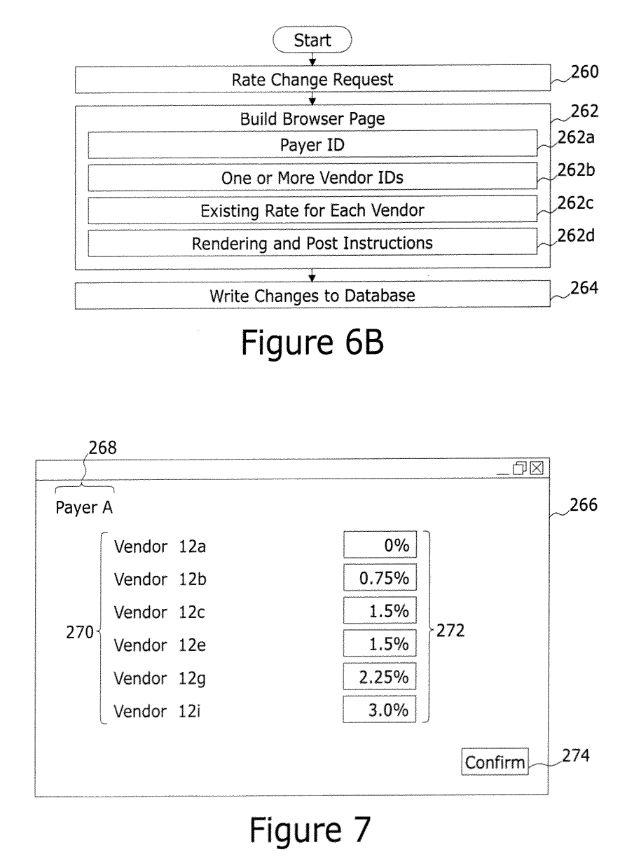

Turning to FIG. 6a, exemplary steps performed by the rate tier assignment application 204 to assign, for a prospective payer, an initial payer specific rate to a vendor are shown. Step 208 represents determining whether the vendor has already been assigned a rate by another payer. If the vendor has already been assigned a rate by one or more other payers (i.e. payer rates are populated into the payer rate records 141 associated with the vendor in the vendor registry 112, FIG. 5a), the rate tier assignment application 204 determines which of the one or more other payers has the most similar payer/vendor relationship with the vendor as the prospective payer at step 209.

More specifically, if the vendor has an assigned rate for only one other payer, that one payer would be the payer with the most similar payer/vendor relationship. If the vendor has an assigned rate with more than one payer, the other payer which pays the vendor the most similar annual payment volume and the most similar payment frequency would be the payer with the most similar payer/vendor relationship.

At step 210, the rate assigned to the vendor, for payments by the prospective payer, would be the same rate that is in effect with the most similar other payer.

Alternatively, if at step 208 it is determined that the vendor has not already been assigned a rate for payments by any other payers (i.e. no payer/rate combinations are populated to the payer rate records 141 in association with the vendor in the vendor registry 112 of FIG. 5a), the rate assignment application 204 executes steps 212 through 230 to assign an initial rate.

Step 212 represents determining the vendor's industry code. The rate tier assignment application 204 may determine the vendor's industry code by retrieving it from the industry code field 135 of the record associated with the vendor in the vendor registry 112 (FIG. 5a). Alternatively, with reference to FIG. 1 in conjunction with FIG. 5a, if the vendor's industry code is not available in the vendor registry 112, the rate tier assignment application 204 may query a SIC code database 233.

The SIC code database 233 may associate the name of each company within a group of companies 234 with the company's industry code. Each company may be identified by its name, tax ID number, or other identifier. In querying the SIC code database 233, the rate tier assignment application may provide the vendor's name, tax ID number, or other identifier and receive, in response, the vendors industry code.

The SIC database 233 may be a remote database accessible over the internet 20 as depicted in FIG. 1, a local database coupled to the system 10, or a local database that is part of database 118 of system 10.

Returning to FIG. 6a, step 214 represents determining the vendor's industry sensitivity score by looking up the industry sensitivity score 236 associated with the vendor's industry code in the sensitivity score table 206 (FIG. 4).

Step 216 represents determining the vendor's payer centric spend score. The vendor's payer centric spend score is a function of the aggregate value of all payments expected to be made by a particular payer, for example payer 14a, to the vendor over a predetermined period of time, such as one calendar year and may be an integer value of one (1) through five (5).

The aggregate amount of payments expected to be made by the particular payer to the vendor over the one year period may be determined based on historical payment information, such as the aggregate amount of payments made by the particular payer to the vendor over the previous year.

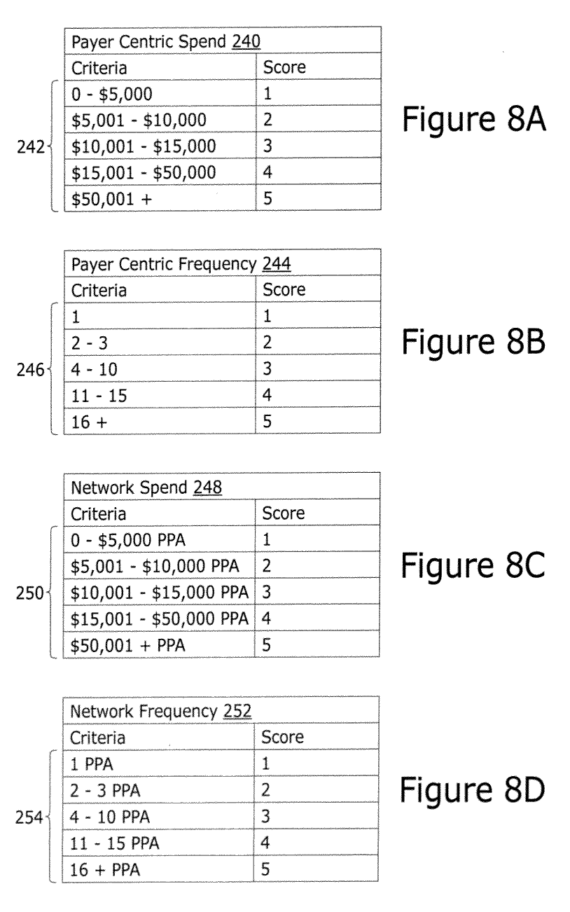

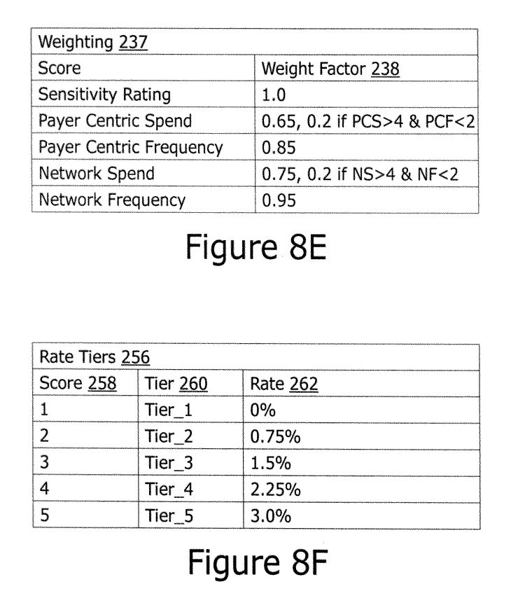

Referring briefly to FIG. 8a in conjunction with FIG. 1, in an exemplary embodiment, the rate tier assignment application 204 may maintain a payer centric spend table 240 (which may be embodied in computer readable medium) which includes a record 242 associated with each score value 1-5. The record designates criteria for assigning the score value. In the exemplary embodiment: i) a score value of 1 is assigned if the aggregate amount of payments expected to be made by the particular payer to the vendor over a one year period is less than or equal to $5,000; ii) a score value of 2 is assigned if the aggregate amount of payments expected to be made by the particular payer to the vendor over a one year period is between $5,001 and $10,000; iii) a score value of 3 is assigned if the aggregate amount of payments expected to be made by the particular payer to the vendor over a one year period is between $10,001 and $15,000; iv) a score value of 4 is assigned if the aggregate amount of payments expected to be made by the particular payer to the vendor over a one year period is between $15,001 and $50,000; and v) a score value of 5 is assigned if the aggregate amount of payments expected to be made by the particular payer to the vendor over a one year period is greater than $50,000.

Step 218 represents determining the vendor's payer centric frequency score. The vendor's payer centric frequency score is a function of the quantity of payments expected to be made by a particular payer, for example payer 14a, to the vendor over a predetermined period of time, such as one calendar year and may be may be an integer value of one (1) through five (5).

The total quantity of payments expected to be made by the particular payer to the vendor over the one year period may be determined based on historical payment information, such as the total quantity of payments made by the particular payer to the vendor over the previous year.

Referring briefly to FIG. 8b in conjunction with FIG. 1, in an exemplary embodiment, the rate tier assignment application 204 may maintain a payer centric frequency table 244 (embodied in computer readable medium) which includes a record 246 associated with each score value 1-5. The record designates criteria for assigning the score value. In the exemplary embodiment: i) a score value of 1 is assigned if the total quantity of payments expected to be made by the particular payer to the vendor over a one year period is no greater than one (1); ii) a score value of 2 is assigned if the total quantity of payments expected to be made by the particular payer to the vendor over a one year period is two (2) to three (3); iii) a score value of 3 is assigned if the total quantity of payments expected to be made by the particular payer to the vendor over a one year period is between four (4) and ten (10); iv) a score value of 4 is assigned if the total quantity of payments expected to be made by the particular payer to the vendor over a one year period is between eleven (11) and fifteen (15); and v) a score value of 5 is assigned if the total quantity of payments expected to be made by the particular payer to the vendor over a one year period is greater than fifteen (15).

Step 220 represents determining the vendor's network spend score. The vendor's network spend score is a function of the aggregate value of all payments expected to be made by all payers within the group of payers 14 to the vendor over a predetermined period of time, such as one calendar year and may be may be an integer value of one (1) through five (5).

The aggregate amount of payments expected to be made to the vendor by multiple payers within the network of payers over the one year period may be determined based on historical payment information, such as the aggregate amount of payments made to the vendor by multiple payers within the network of payers over the previous year.

Referring briefly to FIG. 8c in conjunction with FIG. 1, in an exemplary embodiment, the rate tier assignment application 204 may maintain a network spend table 248 (embodied in computer readable medium) which includes a record 250 associated with each score value 1-5. The record designates criteria for assigning the score value. In the exemplary embodiment: i) a score value of 1 is assigned if the aggregate amount of payments expected to be made to the vendor by multiple payers within the network of payers over a one year period; divided by the number of payers making payment to the vendor to derive a “per payer average” results in a per payer average less than or equal to $5,000; ii) a score value of 2 is assigned if the aggregate amount of payments expected to be made to the vendor by multiple payers within the network of payers over a one year period results in a per payer average between $5,001 and $10,000; iii) a score value of 3 is assigned if the aggregate amount of payments expected to be made to the vendor by multiple payers within the network of payers over a one year period results in a per payer average between $10,001 and $15,000; iv) a score value of 4 is assigned if the aggregate amount of payments expected to be made to the vendor by multiple payers within the network of payers over a one year period results in a per payer average between $15,001 and $50,000; and v) is assigned if the aggregate amount of payments expected to be made to the vendor by multiple payers within the network of payers over a one year period results in a per payer average greater than $50,000.

Step 222 represents determining the vendor's network centric frequency score. The vendor's network frequency score is a function of the totally quantity of payments expected to be made by all payers within the group of payers 14 to the vendor over a predetermined period of time, such as one calendar year and may be may be an integer value of one (1) through five (5).

The total quantity of payments expected to be made to the vendor by multiple payers within the network of payers over the one year period may be determined based on historical payment information, such as the total quantity of payments made to the vendor by multiple payers within the network of payers over the previous year.

Referring briefly to FIG. 8d in conjunction with FIG. 1, in an exemplary embodiment, the rate tier assignment application 204 may maintain a network frequency table 252 (embodied in computer readable medium) which includes a record 254 associated with each score value 1-5. The record designates criteria for assigning the score value. In the exemplary embodiment: i) a score value of 1 is assigned if the total quantity of payments expected to be made to the vendor by multiple payers within the network of payers; divided by the number of payers making payment to the vendor to result in a “per payer average” results in a per payer average of one (1); ii) a score value of 2 is assigned if the total quantity of payments expected to be made to the vendor by multiple payers within the network of payers results in a per payer average of two (2) to three (3); iii) a score value of 3 is assigned if the total quantity of payments expected to be made to the vendor by multiple payers within the network of payers results in a per payer average of four (4) and ten (10); iv) a score value of 4 is assigned if the total quantity of payments expected to be made to the vendor by multiple payers within the network of payers results in a per payer average of eleven (11) and fifteen (15); and v) a score value of 5 is assigned if the total quantity of payments expected to be made to the vendor by multiple payers within the network of payers results in a per payer average of sixteen (16) or greater. In all cases fractional values may be rounded to the nearest integer value, rounded up to the nearest integer value, or rounded down (i.e. truncated) to the nearest integer value.

Returning to FIG. 6a, step 224 represents weighting each score. Referring to the weighting table of FIG. 8e, each score, as determined at steps 214 through 222 is multiplied by a weight factor 238 to determine a weighted score. More particularly, at step 224a, the sensitivity score is weighted (or multiplied by) a factor of 1.0 to determine a weighted industry sensitivity score.

At step 224b the payer centric spend score is weighted by a factor of 0.65 to determine a weighted payer centric spend score. Provided however, in the event the payer centric spend score is greater than four (4) and the payer centric frequency score is less than two (2), the payer centric spend score is weighted by a factor of 0.2 to determine the weighted payer centric spend score.

At step 224c the payer centric frequency score is weighted by a factor of 0.85 to determine a weighted payer centric frequency score.

At step 224d the network spend score is weighted by a factor of 0.75 to determine a weighted network spend score. Provided however, in the event the network spend score is greater than four (4) and the network frequency score is less than two (2), the network spend score is weighted by a factor of 0.2 to determine the weighted network spend score.

At step 224e the network frequency score is weighted by a factor of 0.95 to determine a weighted network frequency score.

Step 226 represents calculating an overall score. The overall score is the average of the weighted industry sensitivity score, the weighted payer centric spend score, the weighted payer centric frequency score, the weighted network spend score, and the weighted network frequency score. It should be appreciated that each weight factor associated with each score may be distinct from other weight factors associated with other scores.

Step 228 represents determining the rate to initially assign to the vendor by mapping the overall score to a rate tier. Referring to FIG. 8f, examples of how the mapping may be performed include: i) rounding the overall score to the closest rate tier score value 258, for example overall score of 2.51 maps to rate Tier_{—}3; and ii) truncating the overall score to the closest rate tier value, for example overall score of 2.51 maps to rate Tier_{—}2.

Step 230 represents associating the rate applicable to payments made by the payer to the vendor by: i) writing a new record 144 to the payer rate records 141 associated with the vendor, such new record including the system ID of the payer in the payer ID field 142 and the rate in the rate field 143.

It should be appreciated that the steps represented by FIG. 6a represent the exemplary embodiment wherein the overall score and the rate assigned for payments by the payer to the vendor are a function of all of the vendor's industry score, payer centric spend score, payer centric frequency score, network spend score, and network frequency score. The scope of the present invention includes determining the overall score and rate assignment as a function of permutations of one or more of any of these scores.

For example, determining the rate based on: i) industry score only (permutation of only one score), ii) industry score, payer centric spend score, and payer centric frequency score (permutation of three scores); and iii) industry score, network spend score, and network frequency score (a different permutation of three scores). When permutations of fewer than all scores are used, the weighted average is based on only those scores that are used.

Turning to FIG. 6b, the rate tier assignment application 204 further includes steps which, when executed by the processor permit a rate assigned to a vendor (for a prospective payer) to be altered by, or at the direction of, the prospective payer.

Step 260 represents a rate change request being provided to the rate tier assignment application 204. In response, the rate tier assignment application 204 builds a render-able object which permits the rate to be altered.

FIG. 7 depicts an exemplary render-able object 266, in graphic form. Referring to FIG. 6b and FIG. 7, step 262 represents populating the payer ID 268 of the prospective payer to the render-able object 266. Step 262b represents populating one or more vendor IDs 270 to the render-able object 266, each vendor ID being for a vendor within the prospective payer's payer vendor group. Step 262c represents populating the existing rate applicable to payments made by the payer to each such vendor as such rates are recorded in the payer rate records 141 associated with the vendor (FIG. 5a).

Step 262d represents populating rendering instructions which may be code necessary for a payer system 49a, 49b, 49c (FIG. 2) to render the render-able object 266 in graphic format and post user entered changes to the existing rate 272 back from the system 49a, 49b, 49c to the rate assignment application 204 in response to user action such as clicking a confirm button 274. Upon receipt of such a post, the rate assignment application 204 writes, at step 263, the updated rates to the applicable fields of payer rate records 141 (FIG. 5a).

Turning to FIG. 1, in operation, the payment system 10 processes payments for each payer within the community of payers 14, for payment of a payment amount from the payer's account to one of the vendors within the community of vendors 12. In one aspect the payment system 10 may process payments for invoice objects within the invoice database 116 (FIG. 5e), including processing an early payment of the invoice by a financier (on an early payment date) and subsequently processing a payment from the payer (on a payment due date) for purposes of repaying the financier.

Referring to the ladder diagram of FIG. 9 in conjunction with FIG. 1, exemplary operation of the payment application 18 for facilitating financing of a vendor's invoice by a financier (which may be a participating bank 28a, 28b) is represented.

Step 300 represents receiving an invoice object from a vendor and populating the invoice object 525 to the invoice database 116 (FIG. 5e), or more specifically populating each information elements from the invoice object to the database.

Step 302 represents receiving an early payment request from the vendor 14 and populating a requested early payment date to field 536 of the record 525 created for the invoice object in the invoice database 116 (FIG. 5e). It should be appreciated that the early payment request may be delivered as part of, or with, the invoice object or may be a separate request made after delivery of the invoice object. The early payment request may include a requested early payment date and in such case the requested payment date as included in the request is populated to field 536. If the request does not include a requested payment date, the date the request is received may, by default, be populated to the field 536.

Step 304 represents requesting approval of early payment financing by a financier. In the exemplary embodiment the financier is the participating bank 28a, 28b with which the payer 12 is associated. As such, there exist contractual privity between the payer and the financier such that the payer's authorization of invoice payment on the due date as described with respect to step 310 becomes contractually binding and the financier is therefore confident that repayment of amounts paid to the vendor for early payment will be forthcoming on the due date.

The request may include identification of the vendor requesting early payment financing, identification of the payer to which the invoice is issued, and the portion of the invoice to be financed, or it may include the entire invoice object. As discussed, the financier may be a participating bank 28a, 28b and the request may be delivered to the banks' financing system 31b which confirms, on an automated basis that: i) the vendor is eligible for financing; ii) the invoice is eligible for financing (i.e. at a minimum the invoice is to a payer which is participating in early payment financing.

Step 306 represents receipt of approval of the financing by the financier and writing the approval, or the date of the approval, to the financier approval field 538 of the record 525 associated with the invoice object in the invoice database 116 (FIG. 5e).

Turning briefly of FIG. 12, in one embodiment, an exemplary early payment approval 340 may include: i) an invoice ID field 342 specifying the invoice that is approved for early payment—by inclusion of the Invoice ID representing the invoice object in the invoice database 116; ii) an early payment date field 344 specifying the earliest date on which early payment is authorized; iii) a finance rate field 346 specifying an interest rate or money factor used for calculating a portion of the finance fee based on the duration of time between the early payment date and the payment due date; iv) a finance charge field 348 specifying a fixed charge portion of the finance fee; v) an identification of the financier transaction account to be used for funding early payment of the invoice and the funding currency 349 (identification of the funding currency may be explicit or identification of the funding currency may be implicit in that it is the currency in which the identified transaction account is denominated) vi) a gross payment amount 350 which is the invoice amount being paid; vii) a finance fee 351, which may be the result of multiplying the finance rate, or a finance rate, by a period of time; and viii) net payment amount 352 which may be the gross payment amount 350 less the applicable finance fee and/or the finance charge.

Returning briefly to FIG. 5e in conjunction with FIG. 9 upon receipt of the approval, as part of step 306, the application 10 may: i) write the earliest date on which early payment is authorized from field 344 of the approval to field 538 of the record 523 associated with the invoice object (i.e. invoice object with payer ID in field 526 which matches the payer ID in field 342 of the approval); ii) write the interest rate or money factor from field 346 of the approval to field 542 of the record 523 associate with the invoice object; and iii) write the fixed charge from the finance charge field 348 of the approval to field 544 of the record 523 associated with the invoice object.

Alternatively, if an early payment date is not specified in the approval 340, the date on which the approval is received may be written to the financer approval field 538 of the record 523 associated with the invoice object.

In yet another alternative, if the early payment approval does not include either: i) an interest rate or money factor; and/or) a fixed charge, the system 10 may write a predetermined interest rate or money factor to field 542 and a default fixed charge to field 544.

Step 308 represents requesting approval of the invoice by the payer 14. This may be an affirmative request or may be by way of monitoring payer activity on the invoice if the payer is using on-line systems of the system 10 for invoice processing.

Step 310 represents receipt of approval of the invoice from the payer 14 and writing payer approval, or the date of payer approval to the payer approval field 540 of the record 525 associated with the invoice object in the invoice database 116. For purposes of this invention, approval of the invoice from the payer: i) confirms that the payer 14 commits, on an unqualified basis, to pay the invoice on the due date as recorded in record 534 of the record 525 associated with the invoice object in the invoice database 116; or ii) authorizes payment of the invoice on the due date by way of the system 10 automatically initiating a debit to the payer's transaction account for payment.

After approval of both the financier and the payer is received, the early payment date may be determined at step 311. The early payment date is the latest of: i) the early payment date requested by the vendor; ii) the date of financier approval (or the earliest date that payment could be made following financier approval to allow for processing time); and iii) the date of payer approval (or the earliest date that payment could be made following payer approval to allow for processing time).

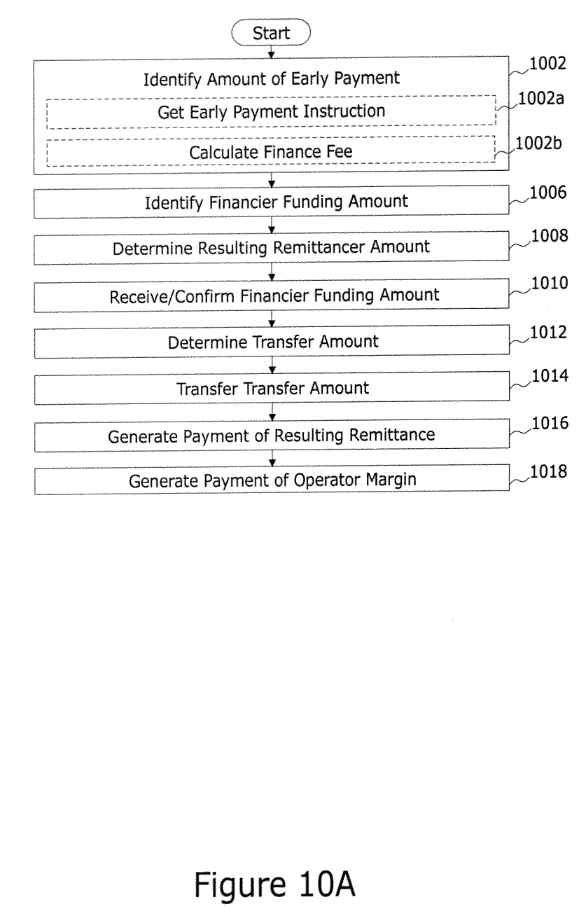

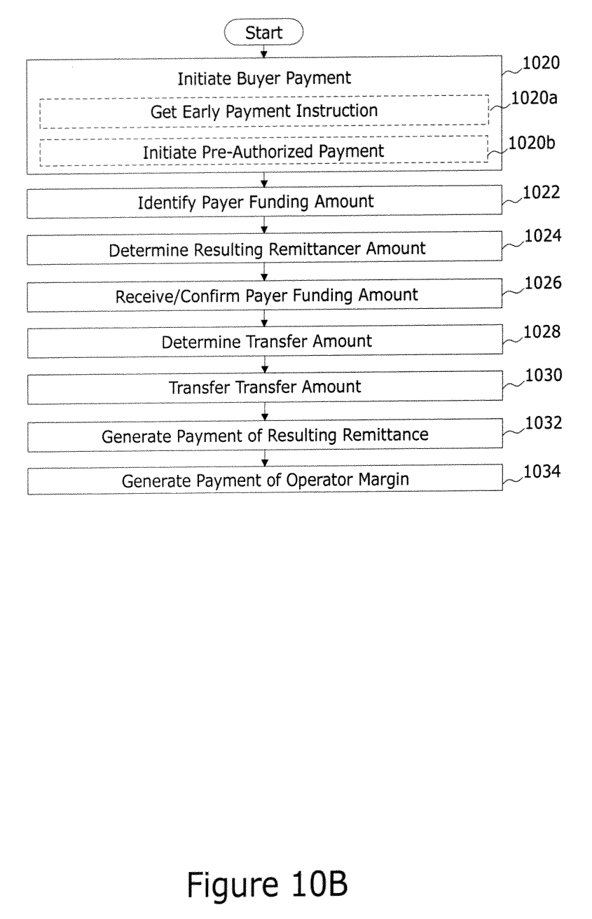

Turning to FIG. 10a, a flow chart representing exemplary instructions of the payment application 18 for initiating early payment of an invoice by a financier on the early payment date is depicted.

Step 1002 represents identifying the amount of an early payment. Identifying the amount of the early payment at step 1002 may comprise looking up the net payment amount 352 from the early payment instruction 340 (FIG. 12) or calculating the amount of the early payment by subtracting the finance fee and/or finance charge (looked up from the early payment instruction 340) from the invoice amount, in each case as represented by step 1002a.

In a second aspect, the payment application 18 may calculate the finance fee as a function of the amount being financed and the duration of time between the early payment date and the due date as represented by stub step 1002b.

For example, referring to FIG. 5e, determining the finance fee may comprise: i) multiplying the amount of the invoice (either amount due from field 530 or the amount due from field 530 plus tax from field 532 of the record 523 associated with the invoice object) by an interest rate or money factor as recorded in the finance rate field 542, converted to a daily rate, by the number of days between the early payment date and the due date; and ii) adding the finance charge from field 544 associated with the invoice object. It should be appreciated that in alternative embodiments, the finance fee may be based on the interest rate only without a fixed finance charge or may be a fixed finance charge only without a component based on interest rate.

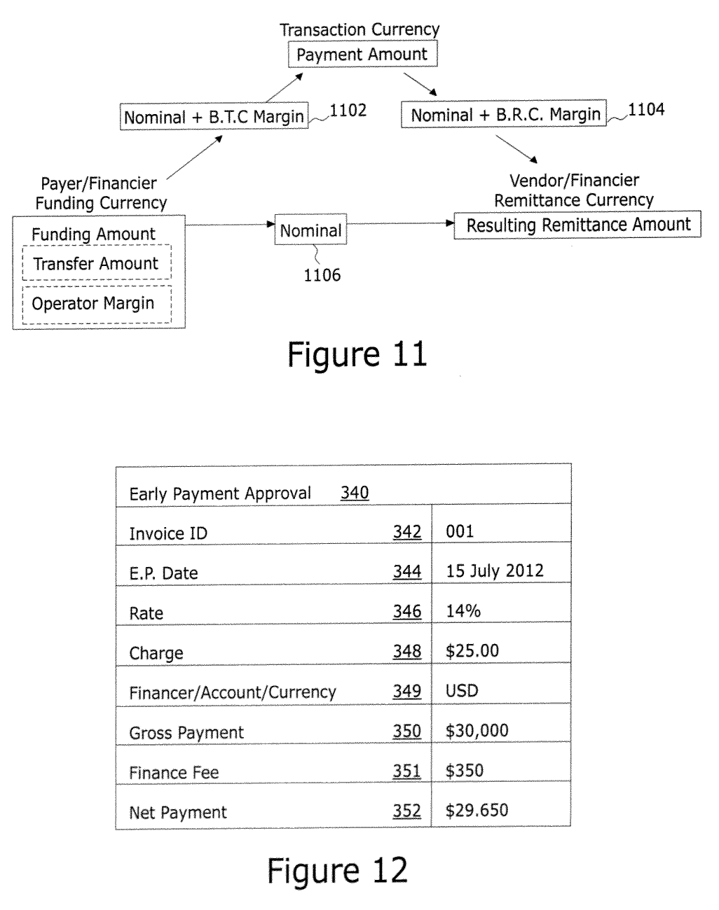

Returning to FIG. 10a, step 1006 represents determining a financier funding amount. Because the financiers funding currency may not be the same as the transaction currency, the financer funding amount is the payment amount converted to the financer currency at a market or nominal exchange for selling financier currency and buying transaction currency plus a margin. Stated differently, it's the amount of funding needed, in the financier's currency, to cover the payment amount when converted to the transaction currency using a market or nominal exchange rate plus a margin as represented by step 1102 in FIG. 11.

1008 represents determining a resulting remittance amount. Because the vendor's remittance currency may not be the same as the transaction currency, the resulting remittance amount is the payment amount converted to the vendor's remittance currency at a market or nominal exchange for selling the transaction currency and buying the vendor's currency plus a margin. Stated differently, it's the amount of remittance currency resulting when the payment amount is converted to the remittance currency using a market or nominal exchange rate plus a margin as represented by step 1104 in FIG. 11.

Step 1010 represents receipt of the funding amount in a settlement account denominated in the financier currency. More specifically, the system may look up, in the participating bank registry 502 (FIG. 5c), the financier record of the participating bank operating as financier, an account number and routing number of the financier's account used to fund invoices 509; looking up the settlement account identifier 510, initiating a transfer of the funding amount from the financier's account sued to fund invoices to the settlement account, and confirming completion of the transfer.

Step 1012 represents determining a transfer amount. The transfer amount is the resulting remittance amount converted to the financer currency at a market or nominal exchange for selling financier currency and buying the vendor's remittance plus a margin. Stated differently, it's the amount of funding needed, in the financier's currency, to cover the resulting remittance amount when converted to the vendor's currency using a market or nominal exchange rate as represented by step 1106 in FIG. 11. It should be appreciated that the transfer amount needed to cover the resulting remittance should be less than the funding amount needed to covert the payment amount resulting in profit (operator margin) to the operator of the system.

Step 1014 represents generating a currency exchange transaction to debit the transfer amount from the settlement account denominated in the financier currency and credit the resulting remittance amount to a settlement account denominated in the vendor's remittance currency. This may include looking up, in the participating bank registry 502 (FIG. 5c), the account number and routing number of the settlement account denominated in the financiers funding currency, looking up the account number and routing number of settlement account denominated in the vendor's remittance currency, and initiating a transfer of the transfer amount from the financier's account sued to fund invoices to the settlement account, and confirming completion of the transfer.

Step 1016 represents generating a payment from the settlement account denominated in the vendor's remittance currency to the vendor's transaction account. This may include looking up, in the participating bank registry 502 (FIG. 5c), the account number and routing number of the settlement account denominated in the vendor's remittance currency, looking up in the vendor registry 112, the remittance account information 140 of the vendor's remittance account, and initiating a transfer of the resulting remittance amount from the settlement account denominated in the vendor's remittance currency to the vendor's remittance account.

Step 1018 represents, to the extent the funding amount determined at step 1006 exceeds the transfer amount determined at step 1012, generating a payment of such excess of the operator of the system 10. This may include initiating a transfer of the excess from the settlement account to the operator account 37 (FIG. 1).

Turning to FIG. 10b, at a subsequent time when the payer makes payment of the invoice or the invoice becomes due, the buyer's payment is initiated at step 1020. In a first embodiment, represented by step 1020a, initiation of the buyer payment is performed upon receipt of payment instructions from the buyer/payer. In a second embodiment, represented by step 1020b, payment is initiated by the system 10 based on preauthorization by the buyer as indicated by the buyer approving payment at step 310 (FIG. 9).

Step 1022 represents determining a payer funding amount. Because the financiers funding currency may not be the same as the transaction currency, the payer funding amount is the payment amount converted to the payer currency at a market or nominal exchange for selling payer currency and buying transaction currency plus a margin. Stated differently, it's the amount of funding needed, in the payer's currency, to cover the payment amount when converted to the transaction currency using a market or nominal exchange rate plus a margin as represented by step 1102 in FIG. 11.

1024 represents determining a resulting remittance amount. Because the financier's remittance currency may not be the same as the transaction currency, the resulting remittance amount is the payment amount converted to the financier's remittance currency at a market or nominal exchange for selling the transaction currency and buying the financier's currency plus a margin. Stated differently, it's the amount of remittance currency resulting when the payment amount is converted to the remittance currency using a market or nominal exchange rate plus a margin as represented by step 1104 in FIG. 11.

Step 1026 represents receipt of the funding amount in a settlement account denominated in the payer's currency. This may include looking up, in the participating payer registry 114 (FIG. 5b), the currency, account number and routing number of the payer's funding account 124, looking up in the participating bank registry 502 (FIG. 5c) the account number and routing number of settlement account denominated in the payer's funding currency, and initiating a transfer of the funding amount from the payer's funding account to the settlement account, and confirming completion of the transfer.

Step 1028 represents determining a transfer amount. The transfer amount is the resulting remittance amount converted to the payer currency at a market or nominal exchange for selling payer currency and buying the financier's remittance plus a margin. Stated differently, it's the amount of funding needed, in the payer's currency, to cover the resulting remittance amount when converted to the financier's currency using a market or nominal exchange rate as represented by step 1106 in FIG. 11. Again, should be appreciated that the transfer amount needed to cover the resulting remittance should be less than the funding amount needed to covert the payment amount resulting in profit (operator margin) to the operator of the system.

Step 1030 represents generating a currency exchange transaction to debit the transfer amount from the settlement account denominated in the payer currency and credit the resulting remittance amount to a settlement account denominated in the financier's remittance currency.

This may include looking up, in the participating bank registry 502 (FIG. 5c), the account number and routing number of the settlement account denominated in the payer currency, looking up the account number and routing number of settlement account denominated in the financier's remittance currency, and initiating a transfer of the transfer amount from the account denominated in the payer currency to the account denominated in the financier's remittance currency.

Step 1032 represents generating a payment in the amount of the resulting payment from the settlement account denominated in the financier's remittance currency to the financier's transaction account. This may include looking up, in the participating bank registry 502 (FIG. 5c), the account number and routing number of the financiers account 509, looking up the account number and routing number of settlement account denominated in the financier's remittance currency, and initiating a transfer of the resulting payment from the settlement account to the financier's account.

Step 1034 represents, to the extent the funding amount determined at step 1022 exceeds the transfer amount determined at step 1030, generating a payment of such excess of the operator of the system 10 in a similar manner as discussed with respect to FIG. 10a.

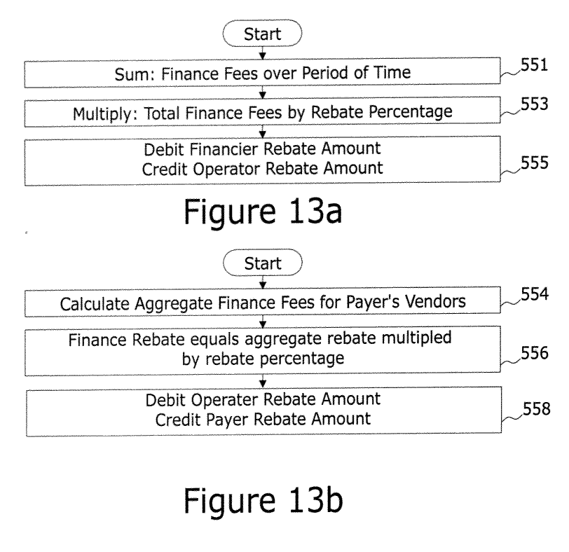

Turning to FIG. 13, exemplary steps of a rebate application for purposes of splitting a portion of the finance fee with the operator are depicted.

Step 551 represents determining the sum of the total finance fees applied to each early payment made by a financer during a predetermined period of time.

Step 553 represents determining an operator portion of the finance fee by multiplying the total finance fee by a fractional value between zero and one, typically 50%, such percentage being the operator portion. As another example, the operator portion may be 30% while the financier portion may be 70%. The financier portion compensates the financier for early payment of the invoice. The operator portion compensates the operator of the system 10 and a portion of the operation portion may be used as a rebate to the payer to encourage the payer to participate in early payment by approving the invoice early.

Step 555 represents debiting the financer account and crediting the operator account, that the operator portion of the finance fee. The currency exchange techniques described with respect to FIG. 11 may be used.

Turning to FIG. 14, in another aspect the rebate application 33 may determine a rebate amount accruing to a payer over a period of time is depicted.

Step 554 represents determining aggregate finance fees charged to vendor's based on early payment of the payer's invoices over the period of time. Stated another way, the aggregate finance fees may be the aggregate of finance fees, or the aggregate of the operator portion of the finance fee calculated as described in FIG. 10a for payments made to vendors and paid by the payer over the period of time.

Step 556 represents multiplying the total finance fee by a finance fee rebate percentage to yield a finance fee rebate. The finance fee rebate percentage may be different than the network fee rebate percentage and may be a percentage between 0% and 100% and preferably between 30% and 50% of the aggregate of the operator portion of the finance fees.

Step 558 represents crediting, to an account of the payer, the network fee rebate amount and the finance fee rebate amount.

In summary, the present invention provides a system for making payments from a payer to a community of vendors and providing vendor financing in a multi-currency situation.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A system for making payments from each payer of a community of payers to each vendor of a community of vendors and providing vendor financing, the system comprising:
a database encoded to computer readable medium, the database comprising:
a group of payer records, each record being associated with and identifying a unique one of the payers within the community of payers and including identification of a payer funding currency, the funding currency being a currency denomination chosen by the payer for payment of invoices;
a group of vendor records, each record being associated with and identifying a unique one of the vendors within the community of vendors and including identification of a vendor remittance currency, the vendor remittance currency being a currency denomination chosen by the vendor for receipt of payment of invoices;
at least one financier record being associated with and including identification of a financier and including identification of a financer currency, the financer currency being a currency denomination chosen by the financier to fund early payment of invoices and subsequently receive remittance of invoice amount from the payer.
a group of invoice objects, each invoice object including identification of a transaction payer, identification of a transaction vendor, identification of an invoice amount, identification of a transaction currency, and identification of a payment due date, the transaction payer being one of the payers of the group of payers and the transaction vendor being one of the vendors within the payer vendor group associated with the transaction payer;
at least one of the transaction currency, payer funding currency, the vendor remittance currency, and the finance currency being a different currency denomination than the other two;
a payment application comprising instructions stored in a computer readable memory and executed by a processor, the instructions comprising:
identifying the payment amount of an early payment, denominated in the transaction currency, the payment amount of the early payment being the invoice amount less a finance fee.
determining a financer funding amount, denominated in the financer currency, the financer funding amount being the payment amount of the early payment converted to the financier currency at a market exchange rate plus a margin.
receiving in a settlement account denominated in the financer currency, the financer funding amount;
determining a vendor resulting remittance amount, denominated in the vendor remittance currency, the vendor resulting remittance amount being the payment amount of the early payment converted to the vendor remittance currency at a market exchange rate plus a margin;
generating a payment of the resulting remittance amount to a vendor remittance account from a settlement account denominated in the vendor remittance currency;
determining a payer funding amount, denominated in the payer currency, the payer funding amount being the invoice amount converted to the payer funding currency at a market exchange rate plus a margin;
receiving in a settlement account denominated in the payer funding currency, the payer funding amount;
determining a financer payment amount, denominated in the financier so currency, the financier payment amount being the invoice amount converted to the financer currency at a market exchange rate plus a margin; and
generating a payment of the financer payment amount to a financier remittance account from the settlement account denominated in the financer currency.

2. The system of claim 1:
further comprising an early payment instruction received from the financer and coded to the computer readable database, the early payment instruction comprising an invoice identifier and identification of the finance fee denominated in the transaction currency; and
the instructions for identifying the payment amount of an early payment comprises looking up the finance fee from the payment instruction received for the financier.

3. The system of claim 2 wherein the instructions of the payment application further comprise:
determining a first transfer amount, the first transfer amount being an amount, denominated in the financer currency, necessary to yield the resulting remittance amount when converted to the vendor remittance currency;
executing a currency exchange transaction to debit the first transfer amount from settlement account denominated in the financier currency and credit the vendor payment amount to the settlement account denominated in the vendor remittance currency; and
if the financer funding amount exceeds the first transfer amount, crediting the excess to an operator account.

4. The system of claim 3, wherein the instructions of the payment application further comprise:
determining a second transfer amount, the second transfer amount being an amount, denominated in the payer currency, necessary to yield the financier payment when converted to the financier currency;
executing a currency exchange transaction to debit the second transfer amount from a settlement account denominated in the payer currency and credit the financier resulting payment amount to a settlement account denominated in the financier currency; and
if the payer funding amount exceeds the second transfer amount, crediting the excess to the operator account.

5. The system of claim 1, wherein the instructions for identifying the payment amount of an early payment comprises calculating the finance fee to charge to the transaction vendor as a function of a finance fee rate multiplied by the period of time between the early pay date and the payment due date.

6. The system of claim 5, wherein the instructions of the payment application further comprise:
determining a first transfer amount, the first transfer amount being an amount, denominated in the financer currency, necessary to yield the vendor payment amount when converted to the vendor remittance currency;
executing a currency exchange transaction to debit the first transfer amount from settlement account denominated in the financier currency and credit the vendor payment amount to the settlement account denominated in the vendor remittance currency; and
if the financer funding amount exceeds the first transfer amount, crediting the exceeds to an operator account.

7. The system of claim 6, wherein the instructions of the payment application further comprise:
determining a second transfer amount, the second transfer amount being an amount, denominated in the payer currency, necessary to yield the financier payment when converted to the financier currency;
executing a currency exchange transaction to debit the second transfer amount from a settlement account denominated in the payer currency and credit the financier resulting payment amount to a settlement account denominated in the financier currency; and
if the payer funding amount exceeds the second transfer amount, crediting the excess to the operator account.

8. The system of claim 1; further comprising a rebate application, the rebate application comprising instructions stored in a memory and executed by a processor, the instructions comprising:
determining a total finance fee, the total finance fee being the sum of each finance fee applied to each early payment made by a financier during the predetermined period of time;
determining an operator portion of the finance fee, the operator portion of the finance fee being the product of the total finance fee multiplied by a fractional value between zero and one; and
debiting the financier account and crediting the operator account, the operator portion of the finance fee.

9. A system for making payments from each payer of a community of payers to each vendor of a community of vendors and providing vendor financing, the system comprising:
a database encoded to computer readable medium, the database comprising:
a group of payer records, each record being associated with and identifying a unique one of the payers within the community of payers and including identification of a payer funding currency, the funding currency being a currency denomination chosen by the payer for payment of invoices;
a group of vendor records, each record being associated with and identifying a unique one of the vendors within the community of vendors and including identification of a vendor remittance currency, the vendor remittance currency being a currency denomination chosen by the vendor for receipt of payment of invoices;
at least one financier record being associated with and including identification of a financier and including identification of a financer currency, the financer currency being a currency denomination chosen by the financier to fund early payment of invoices and subsequently receive remittance of invoice amount from the payer.
a group of invoice objects, each invoice object including identification of a transaction payer, identification of a transaction vendor, identification of an invoice amount, identification of a transaction currency, and identification of a payment due date, the transaction payer being one of the payers of the group of payers and the transaction vendor being one of the vendors within the payer vendor group associated with the transaction payer;
at least one of the transaction currency, payer funding currency, the vendor remittance currency, and the finance currency being a different currency denomination than the other two;
a payment application comprising instructions stored in a computer readable memory and executed by a processor, the instructions comprising:
identifying the payment amount of an early payment, denominated in the transaction currency, the payment amount of the early payment being the invoice amount less a finance fee.
determining a financer funding amount, denominated in the financer currency, the financer funding amount being the payment amount of the early payment converted to the financier currency at a market exchange rate plus a margin.
determining a vendor resulting remittance amount, denominated in the vendor remittance currency, the vendor resulting remittance amount being the payment amount of the early payment converted to the vendor remittance currency at a market exchange rate plus a margin;
generating a debit of the financier's transaction account in the amount of the financier funding amount and a credit of the resulting remittance amount to a vendor remittance account;
determining a payer funding amount, denominated in the payer currency, the payer funding amount being the invoice amount converted to the payer funding currency at a market exchange rate plus a margin;
determining a financer resulting payment amount, denominated in the financier currency, the financier resulting payment amount being the invoice amount converted to the financer currency at a market exchange rate plus a margin; and
generating a debit of the payer's transaction account in the amount of the payer funding amount and a credit of the financier resulting payment amount to a so financier remittance account;

10. The system of claim 9:
further comprising an early payment instruction received from the financer and coded to the computer readable database, the early payment instruction comprising an invoice identifier and identification of the finance fee denominated in the transaction currency; and
the instructions for identifying the payment amount of an early payment comprises looking up the finance fee from the payment instruction received for the financier.

11. The system of claim 10, wherein the instructions of the payment application further comprise:
determining a first transfer amount, the first transfer amount being an amount, denominated in the financer currency, necessary to yield the resulting remittance amount when converted to the vendor remittance currency;
executing a currency exchange transaction to debit the first transfer amount from a settlement account denominated in the financier currency and credit the vendor payment amount to a settlement account denominated in the vendor remittance currency; and
if the financer funding amount exceeds the first transfer amount, crediting the excess to an operator account.

12. The system of claim 11, wherein the instructions of the payment application further comprise:
determining a second transfer amount, the second transfer amount being an amount, denominated in the payer currency, necessary to yield the financier payment when converted to the financier currency;
executing a currency exchange transaction to debit the second transfer amount from a settlement account denominated in the payer currency and credit the financier resulting payment amount to a settlement account denominated in the financier currency; and
if the payer funding amount exceeds the second transfer amount, crediting the excess to the operator account.

13. The system of claim 9, wherein the instructions for identifying the payment amount of an early payment comprises calculating the finance fee to charge to the transaction vendor as a function of a finance fee rate multiplied by the period of time between the early pay date and the payment due date.

14. The system of claim 13, wherein the instructions of the payment application further comprise:
determining a first transfer amount, the first transfer amount being an amount, denominated in the financer currency, necessary to yield the vendor payment amount when converted to the vendor remittance currency;
executing a currency exchange transaction to debit the first transfer amount from a settlement account denominated in the financier currency and credit the vendor payment amount to a settlement account denominated in the vendor remittance currency; and
if the financer funding amount exceeds the first transfer amount, crediting the exceeds to an operator account.

15. The system of claim 14, wherein the instructions of the payment application further comprise:
determining a second transfer amount, the second transfer amount being an amount, denominated in the payer currency, necessary to yield the financier payment when converted to the financier currency;
executing a currency exchange transaction to debit the second transfer amount from a settlement account denominated in the payer currency and credit the financier resulting payment amount to a settlement account denominated in the financier currency; and
if the payer funding amount exceeds the second transfer amount, crediting the excess to the operator account.

16. The system of claim 19, further comprising a rebate application, the rebate application comprising instructions stored in a memory and executed by a processor, the instructions comprising:
determining a total finance fee, the total finance fee being the sum of each finance fee applied to each early payment made by a financier during the predetermined period of time;
determining an operator portion of the finance fee, the operator portion of the finance fee being the product of the total finance fee multiplied by a fractional value between zero and one; and
debiting the financier account and crediting the operator account, the operator portion of the finance fee.
